(19) United States
(12) Patent Application Publication
(10) Pub. No.: US 2003/0039429 A1
(43) Pub. Date: Feb. 27, 2003

(54) Scattering type near-field probe, and method of manufacturing the same

(75) Inventors: Tsutomu Inoue, Hachioji (JP); Shigeyuki Kimura, Hachioji (JP); Yoshihito Narita, Hachioji (JP)

Correspondence Address: OLIFF & BERRIDGE, PLC, P.O. BOX 19928, ALEXANDRIA, VA, 22320, US

(73) Assignee: JASCO CORPORATION, Tokyo (JP)

(21) Appl. No.: 10/192,592

(22) Filed: Jul. 11, 2002

(30) Foreign Application Priority Data
Aug. 22, 2001 (JP) 2001-251785

(51) Int. Cl. G02B 6/26; G01N 21/47

(52) U.S. Cl. 385/12; 385/43; 385/30; 356/337

(57) ABSTRACT

A scattering type near-field probe for use in a near-field optical apparatus, capable of freely controlling its probe shape, having a high lot-to-lot shape stability, and improving the lot-to-lot resonant frequency offset, is provided The probe of the invention comprises a glass fiber having at its extremity a core projecting portion coated with a metal. A method of manufacturing thereof comprises the steps of: forming the core projecting portion at an extremity of the glass fiber, by etching the extremity of the glass fiber using chemical etching process; and coating the core projecting portion with a metal.

### RELATED APPLICATIONS

This application claims the priority of Japanese Patent Application No. 2001-251785 filed on Aug. 22, 2001, which is incorporated herein by reference.

### FIELD OF THE INVENTION

The present invention relates generally to a scattering type near-field probe and a method of manufacturing the same, and more particularly to an improvement in shape of the probe.

### BACKGOUND OF THE INVENTION

Of late years, a near-field optical apparatus having a smaller spatial resolution than the wavelength of light and capable of spectrometry have been developed in expectation of its practical application

This near-field optical apparatus is classified into several types by the method of measuring. One example is a scattering type where light from a light source is directly irradiated on a sample so as to form a field of evanescent light on the sample surface, with a sharpened probe entering the field to scatter the evanescent light so that the scattered light and emitted light from the sample is gathered for detection.

Another example is a type where light from the light source is directed through a fiber to a minute opening formed at the tip of the probe so that the field of evanescent light emerging from the opening to the vicinity of the probe tip is irradiated on a sample to gather and detect the scattered light and emitted light from the sample. A further example is a type where the scattered light and emitted light from the sample is gathered through the minute opening at the probe tip by way of the fiber

Herein, the above field of evanescent light is distributed in the area up to several of nanometers from the surface of the sample. The distance between the probe tip and the sample is regulated within a microscopic distance less than the light wavelength of this visible-ultraviolet light whereby information on unevenness of the sample surface can be obtained at high resolution

The scattering type near-field optical apparatus principally employs a shear force feedback system for the purpose of regulating the distance between the probe tip and the sample. This system allows the probe and the sample to come closer to each other while minutely vibrating the probe at a resonance frequency of the probe at which the probe stably vibrates. When the probe tip enters the field of evanescent light occurring over the surface to be measured of the sample, a force called shear force is exerted between the probe and the sample so as to damp the minute vibration of the probe Between the degree of damping and the probe-sample distance there is a certain correlation defined depending on the conditions of the probe, sample, etc. Thus, through the probe-sample distance control to keep the degree of damping constant, information on unevenness of the sample surface is obtained by scanning the sample surface while keeping the probe-sample distance unvaried at all times.

For this purpose, a spot laser, etc., is irradiated on the probe in order to detect the amplitude of the probe minute vibration, and the intensity of the reflected light modulated as a result of vibration of the probe is detected so that a change in the amplitude of the probe vibration is found out.

Up until now, the scattering type probe has been formed from an extremely thin metal rod which has undergone electrolytic polishing.

More specifically, the probe was obtained by performing electrolysis using a fibrous metal as one electrode so that a part of the metal is dissolved as ions in a solution to thereby sharpen the tip thereof

In terms of measurement conditions, the most preferred probe shape is such that the dimensions of the tip portion most proximate to the sample to be measured conform to the measurement scale order.

Thus, the conditions as shown in FIG. 1(A) are most preferred, whilst the cases where the dimensions of the probe tip portion 4 are much larger and smaller than the measurement scale as shown in FIGS. 1(B) and 1(C), respectively, are not preferred from the viewpoint of the measurement conditions.

In the event of manufacturing the scattering type probe from the electrolytically polished metal rod as in the prior art, however, it was difficult to form the probe into a desired shape and to regulate the probe so as to have a preferred shape in terms of the measurement conditions, as shown in FIG. 1(A)

Furthermore, that probe shape is limited to one having a metal rod 6 with a tapered tip like a probe 8 shown in FIG. 2. Use of the electrolysis also imposed a restriction on the type of available metal

Furthermore, such a conventional manufacturing method made it difficult to obtain the same probe at a high accuracy among a plurality of probes manufactured under the same conditions Thus, there occurred a problem that the probe shape was subjected to lot-to-lot variations

Too large variations in the probe shape may result in lot-to-lot errors of the probe resonant frequency. The probe as expendable supplies needs to be replaced with new one. If the two probes before and after replacement had an error of the resonant frequency, inconveniently it was necessary to change setting of a vibration generator for vibrating the probe at the resonant frequency

### SUMMARY OF THE INVENTION

The present invention was conceived in view of the above problems It is therefore the object of the present invention to provide a scattering type near-field probe capable of freely controlling its probe shape, having a high lot-to-lot shape stability, and improving the lot-to-lot resonant frequency offset

In order to attain the above object, according to the present invention there is provided a scattering type near-field probe for use in a near-field optical apparatus which allows the surface of an object to be measured and the probe tip to come into close proximity to each other, to thereby scatter evanescent light so that information on the object to be measured is acquired from the scattered light, comprising a glass fiber having at its extremity a core projecting portion coated with a metal.

In the scattering type near-field probe, the core projecting portion preferably has a multi-stage tapered shape comprising a first-stage tapered shape formed at the tip of the core projecting portion, and second or subsequent-stage tapered shapes contiguous with or from the base of the first-stage tapered shape, the second or subsequent-stage tapered shapes having different taper angles from each other and from the first-stage tapered shape. In this case, the taper angle may become smaller in sequence from the first-stage tapered shape toward the second or subsequent-stage tapered shapes. Alternatively, the taper angle of the first-stage tapered shape may be smaller than the taper angle of the second-stage tapered shape

Also, in order to achieve the above object, according to the present invention there is provided a method of manufacturing a scattering type near-field probe for use in a near-field optical apparatus which allows the surface of an object to be measured and the probe tip to come into close proximity to each other, to thereby scatter evanescent light so that information on the object to be measured is acquired from the scattered light, the method comprising the steps of. forming a core projecting portion at an extremity of a glass fiber, by etching the extremity of the glass fiber using chemical etching process; and coating the pointed portion with a metal.

In the above method, the step of forming a core projecting portion preferably includes a step of forming a multi-stage tapered shape, which comprises immersing in sequence the extremity of the glass fiber in a plurality of different etching solutions having different dissolution speed ratio of the core relative to a cladding portion, to thereby form a first-stage tapered shape and forming in sequence second or subsequent tapered shapes so as to be contiguous with or from the base of the first-stage tapered shape, the second or subsequent tapered shapes having different taper angles from each other and from the first-stage tapered shape

### BRIEF DESCRIPTION OF THE DRAWINGS

The above and other objects, features and advantages of the present invention will become more apparent from the following detailed description when taken in conjunction with the accompanying drawings, in which

FIGS. 1(A) to 1(C) are schematic explanatory views of the relationship between the probe tip and the measurement scale;

FIG. 2 is a schematic explanatory view of a conventional scattering type near-field probe,

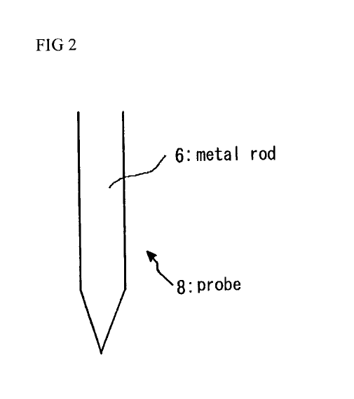

FIG. 3 is a schematic explanatory view of a near-field optical apparatus employing a probe of the present invention;

FIGS. 4(A) and 4(B) are schematic explanatory views of a scattering type near-field probe of the present invention,

FIGS. 5(A) to 5(C) are schematic explanatory views of a method of manufacturing the scattering type near-field probe of the present invention;

FIGS. 6(A) and 6(B) are schematic explanatory views of the method of manufacturing the scattering type near-field probe of the present invention; and

FIGS. 7(A) and 7(B) are schematic explanatory views of the method of manufacturing the scattering type near-field probe of the present invention

### DETAILED DESCRIPTION OF THE PREFERRED EMBODIMENT

An embodiment of the present invention will now be described with reference to the accompanying drawings

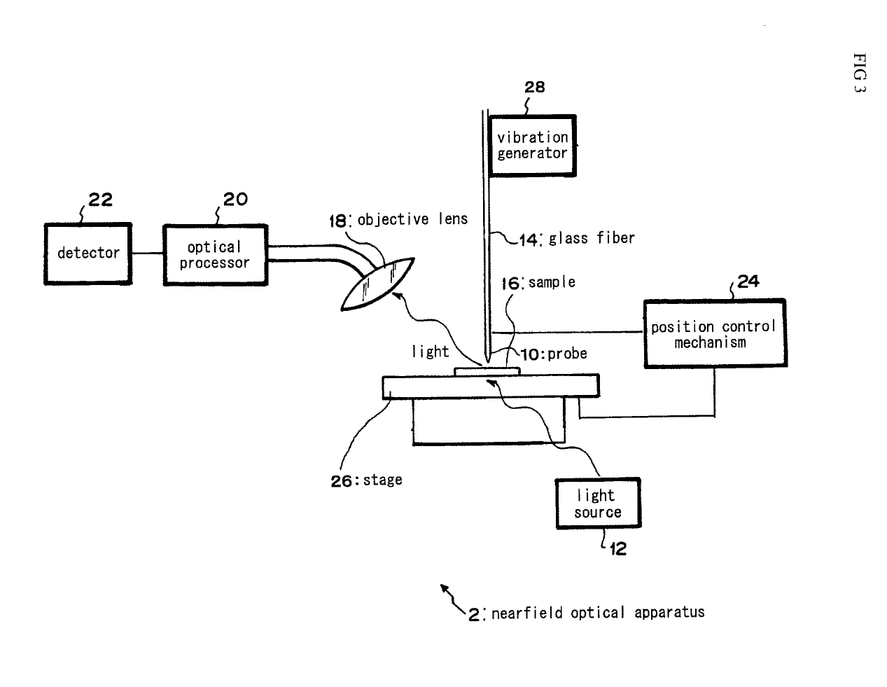

FIG. 3 schematically shows a near-field optical apparatus employing a probe in accordance with the present invention. The near-field optical apparatus is generally designated at 2 in FIG. 3 and effects its sample measurement as follows. A light source 12 such as a laser irradiates light on a sample 16 to be measured, disposed on a stage 26, from the opposite side to the surface to be measured. Then, a field of evanescent light occurs in a minute region less than the visible-ultraviolet light wavelength, in the vicinity of the surface to be measured of the sample

When the tip of the probe 10 comes closer to the sample 16 to be measured and enters the field of evanescent light, the evanescent light scatters or the sample 16 to be measured emits light by the action of the evanescent light. Light to be measured such as the scattered light and the emitted light is gathered by an objective lens 18, and the gathered light is directed to an optical processor 20 and to a detector 22, for detection of information on the sample

The probe is connected to a vibration generator 28 included in the apparatus and vibrates at a resonant frequency of the probe 10 When the tip of the probe 10 enters the region of a field of evanescent light occurring over the sample surface to be measured, a shear force is exerted between the probe and the sample and the vibration of the probe 10 is damped Between the degree of damping and the probe-sample distance there is a certain correlation determined depending on the conditions of the probe, the sample, etc Thus, information on unevenness of the sample surface is obtained by scanning the sample surface while controlling the probe-sample distance so as to keep the damping degree constant.

To detect the amplitude of the minute vibration of the probe, a position control mechanism 24 is provided that includes a source of light such as a spot laser for irradiation onto the probe and a detector for detecting the intensity of reflected light of light from the source, modulated by vibrations of the probe The position control mechanism 24 detects a change in the amplitude of the vibration of the probe such that based on the result of detection the position of the stage 26 is regulated to control the distance between the probe tip and the sample

The probe of the present invention for use in such a scattering type near-field optical apparatus is manufactured by the steps of etching the extremity of the glass fiber by chemical etching process to form the shape of the probe; and coating the extremity of the glass fiber formed with the probe shape through the etching process, with a metal by sputtering process, etc

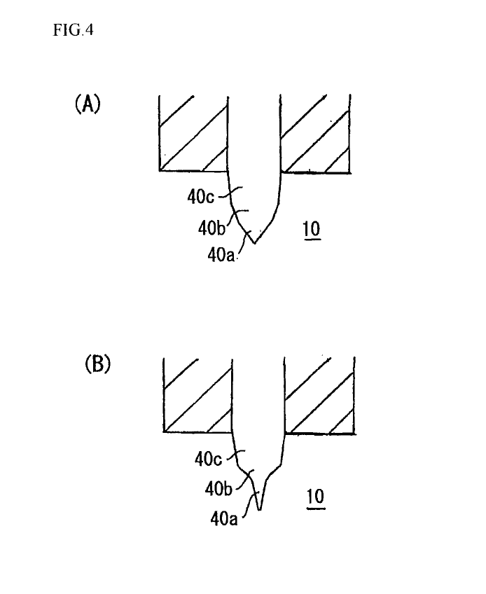

Use of such a glass fiber enables various shapes to be imparted to the probe For example, as shown in FIGS. 4(A) and 4(B), a multi-stage tapered probe could also be obtained that includes a first-stage tapered shape 40a formed at the tip of the probe 10, and a second-stage 40b, a third-stage 40c or subsequent stage tapered shapes, each having a different taper angle and formed in such a manner as to be contiguous with or from the base of the first-stage tapered shape 40a In this case, it would also be possible to manufacture one shaped as shown in FIG. 4(A) where the taper angle becomes smaller in sequence from the first-stage tapered shape toward the second-stage or subsequent-stage tapered shapes, or one shaped as shown in FIG. 4(B) where the taper angle of the first-stage tapered shape is smaller than that of the second-stage tapered shape

Description will hereinafter be made of the probe shape forming step by the chemical etching process using the glass fiber.

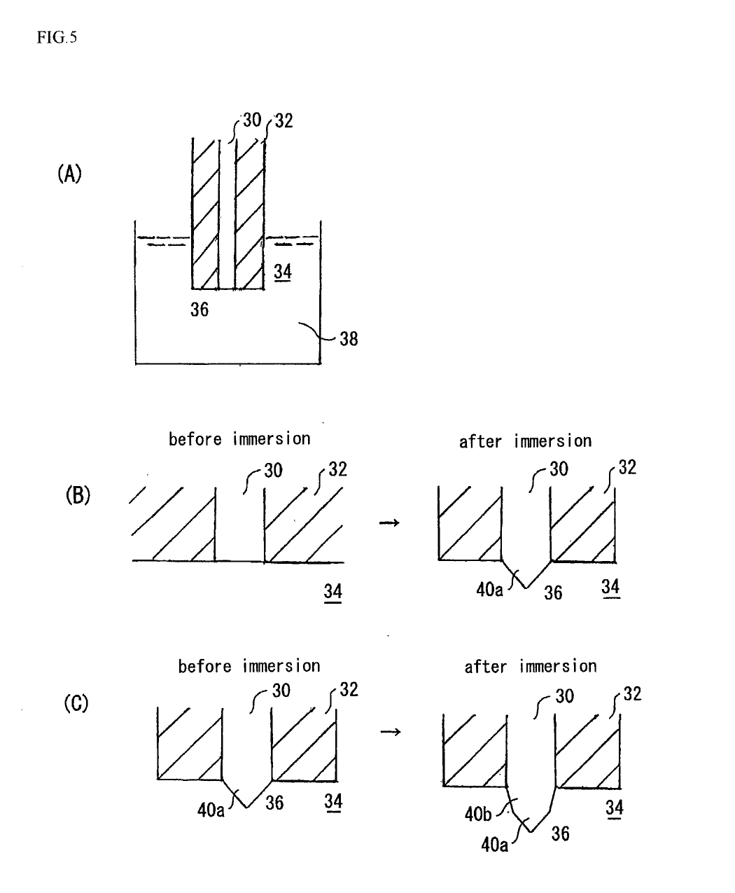

First, as shown in FIG. 5(B), a core projecting portion 36 is formed at an extremity 34 of the glass fiber 14 which consists of a single-layer core 30 made of SiO₂/GeO₂, and a cladding portion 32 covering the periphery of the core. Then, as shown in FIG. 5(A), the glass fiber extremity 34 having a circular section is immersed in a hydrofluoric acid buffer solution 38 (first etchant) of NH₄F.HF.H₂O=X 1.1 so as to selectively sharpen the core while removing the cladding end as shown in FIG. 5(B). For example, if the glass fiber end with the circular-section extremity 34 of 125 μm in diameter is immersed for 90 minutes in the first etchant of NH₄F HF.H₂O=1.8 1 1, then the fiber end partly dissolves to reduce its diameter to about 30 μm, and at its central portion, the core projecting portion 36 is formed having the tapered shape 40a

Then, the composition ratio X of the NH₄F in the hydrofluoric acid buffer solution is varied, and a second etchant is prepared in which the dissolution speed of the core relative to the cladding portion is slower than the case of immersion in the first etchant. When the fiber end is immersed in the second etchant, the core and the cladding portion partly dissolve, as a result of which as shown in FIG. 5(C) at the core projecting portion 36 is formed the second-stage tapered shape 40b contiguous with the base of the first-stage tapered shape 40a By determining the composition of the second etchant in this manner, the taper angle of the second-stage tapered shape 40b can be controlled to be smaller than that of the first-stage tapered shape 40a.

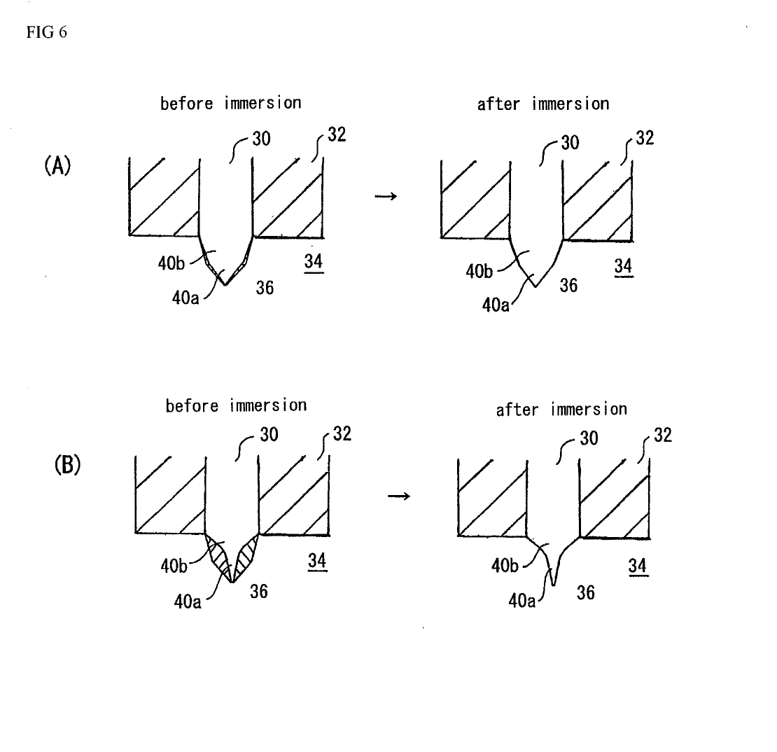

Then, as shown in FIG. 6, the surface side of the core projecting portion 36 with the two-stage tapered shape is further etched and partly removed. Using other proper composition of the hydrofluoric acid buffer solution instead of NH₄F.HF:H₂O=X 1.1 described above, another solution (third etchant) is prepared in which only the core is substantially etched while the fiber extremity 34 is immersed. The fiber extremity 34 having the two-stage tapered core projecting portion 36 is immersed in the third etchant to thereby partly remove the surface side of the core projecting portion.

In case of forming the core projecting portion 36 with the second-stage and third-stage tapered shapes such that the taper angle becomes smaller in sequence from the first-stage tapered shape, the composition of the third etchant, the immersion time, etc., are regulated so that the fiber extremity 34 is withdrawn from the third etchant, with the taper angle of the second-stage tapered shape 40b being smaller than that of the first-stage tapered shape 40a as shown in FIG. 6(A), to cease the removal of the surface side of the core projecting portion

For example, the fiber extremity 34 having the first-stage tapered shape 40a formed thereon under the conditions exemplified hereinabove is immersed for 5 minutes in the second etchant of NH₄F.HF H₂O=10.1:1 so as to form the two-stage tapered core 36 projecting up to about 500 nm, after which it is immersed for 20 seconds in the third etchant of NH₄F HF.H₂O=1 8.1.5 so that the surface side of the core projecting portion can partly be removed with the taper angle of the second-stage tapered shape being smaller than that of the first-stage tapered shape It would also be possible to control the process to remove the surface side of the core projecting portion while monitoring by an electron microscope, etc

In the event of rendering the taper angle of the first-stage tapered shape smaller than that of the second-stager tapered shape, the composition of the third etchant, the immersion time, etc., are regulated so that the fiber extremity 34 is withdrawn from the third etchant, with the taper angle of the first-stage tapered shape 40a being smaller than that of the second-stage tapered shape 40b as shown in FIG. 6(B), to cease the removal of the surface side of the core projecting portion

For example, the fiber extremity 34 having the first-stage tapered shape 40a form thereon under the conditions exemplified hereinabove is immersed for 10 minutes in the second etchant of NH₄F.HF H₂O=10.1.1 so as to form the two-stage tapered core 36 projecting up to about 1000 nm, after which it is immersed for 1 minute in the third etchant of NH₄F.HF.H₂O=1 8.1:5 so that the surface side of the core projecting portion can partly be removed with the taper angle of the second-stage tapered shape being smaller than that of the first-stage tapered shape

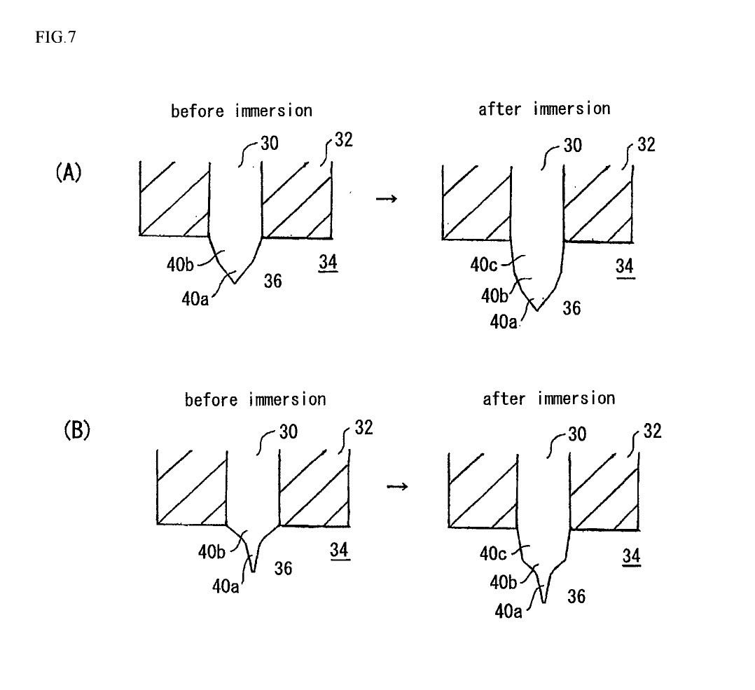

Then, as shown in FIGS. 7(A) and 7(B), the fiber end having the two-stage tapered core created by the above procedure is immersed in the second etchant to form the third-stage tapered shape contiguous further with the base of the second-stage tapered shape

Thus, in the event of forming the taper angle of the second-stage tapered shape so as to be smaller than the taper angle of the first-stage tapered shape 40a, as shown in FIG. 6(A), the third-stage tapered shape 40c is formed having a smaller taper angle than that of the second-stage tapered shape 40b as shown in FIG. 7(A).

For example, in case of forming the two-stage tapered core under the conditions exemplified hereinabove, the fiber extremity 34 is immersed for 15 minutes in the second etchant to manufacture a three-stage tapered core 36.

In the event of forming the taper angle of the second-stage tapered shape 40b so as to be larger than that of the first-stage tapered shape 40a as shown in FIG. 6(B), the third-stage tapered shape 40c is formed having a smaller taper angle than that of the second-stage tapered shape 40b as shown in FIG. 7(B)

For example, in case of forming the two-stage tapered core under the conditions exemplified hereinabove, the fiber extremity 34 is immersed for 15 minutes in the second etchant to manufacture a three-stage tapered core 36.

It would also be possible to obtain a multi-stage probe including three or more stages, by sequentially etching the fiber end using another etchant having a proper composition, in addition to the above manufacturing steps.

The surface of the three-stage tapered core projecting portion thus formed is coated with metal by use of known vapor deposition process, sputtering process, etc., to manufacture the scattering type near-field probe

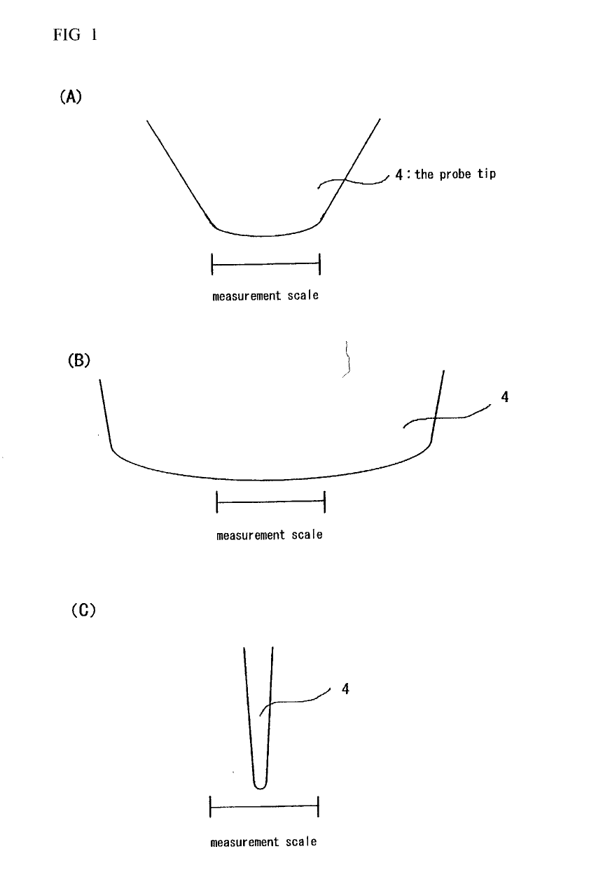

The scattering type near-field probe formed from the glass fiber coated with metal in this manner allows formation of various probe shapes as well as control to the shape suited for the individual measurements as shown in FIG. 1(A), unlike the conventional probe obtained by electrolytically polishing the metal rod. It also enables various kinds of metals to be selected

Furthermore, since the probe shape can be formed into a desired shape at a high accuracy, the lot stability of the resonant frequency is improved.

As set forth hereinabove, according to the present invention there is provided a scattering type near-field probe and a method of manufacturing the same, capable of freely controlling the shape of the probe, having a high lot-to-lot shape stability, and improving lot-to-lot resonant frequency offsets

While illustrative and presently preferred embodiments of the present invention have been described in detail herein, it is to be understood that the inventive concepts may be otherwise variously embodied and employed and that the appended claims are intended to be construed to include such variations except insofar as limited by the prior art.

1. A scattering type near-field probe for use in a near-field optical apparatus which allows the surface of an object to be measured and the probe tip to come into close proximity to each other, to thereby scatter evanescent light so that information on the object to be measured is acquired from the scattered light,
comprising a glass fiber having at its extremity a core projecting portion coated with a metal.

2. The scattering type near-field probe according to claim 1, wherein
said core projecting portion has a multi-stage tapered shape comprising a first-stage tapered shape formed at the tip of the core projecting portion, and second or subsequent-stage tapered shapes contiguous with or from the base of the first-stage tapered shape, the second or subsequent-stage tapered shapes having different taper angles from each other and from the first-stage tapered shape.

3. The scattering type near-field probe according to claim 2, wherein
the taper angle becomes smaller in sequence from said first-stage tapered shape toward said second or subsequent-stage tapered shapes.

4. The scattering type near-field probe according to claim 2, wherein
the taper angle of said first-stage tapered shape is smaller than the taper angle of said second-stage tapered shape

5. A method of manufacturing a scattering type near-field probe for use in a near-field optical apparatus which allows the surface of an object to be measured and the probe tip to come into close proximity to each other, to thereby scatter evanescent light so that information on the object to be measured is acquired from the scattered light, the method comprising the steps of
forming a core projecting portion at an extremity of a glass fiber, by etching the extremity of the glass fiber using chemical etching process, and
coating the core projecting portion with a metal

6. The method of manufacturing a scattering type near-field probe according to claim 5, wherein
the step of forming a core projecting portion comprises a step of forming a multi-stage tapered shape, which comprises immersing in sequence the extremity of the glass fiber in a plurality of different etching solutions having different dissolution speed ratio of the core relative to a cladding portion, to thereby form a first-stage tapered shape, and in sequence second or subsequent tapered shapes so as to be contiguous with or from the base of the first-stage tapered shape, the second or subsequent tapered shapes having different taper angles from each other and from the first-stage tapered shape.
